(19) United States
(12) Patent Application Publication
(10) Pub. No.: US 2026/0149621 A1
(43) Pub. Date: May 28, 2026

(54) SYSTEM AND METHOD FOR ESTABLISHING HIGH SPEED CONNECTIONS FOR DEVICES IN A HOST BASED ARCHITECTURE

(71) Applicant: Cornami, Inc., Dallas, TX (US)

(72) Inventors: Keith Evans, Dallas, TX (US); M. Akif Saglam, Dallas, TX (US); Martin Alan Franz, II, Dallas, TX (US)

(21) Appl. No.: 18/962,115

(22) Filed: Nov. 27, 2024

(51) Int. Cl. H04L 12/40; H04L 45/021

(52) U.S. Cl. CPC H04L 12/40006; H04L 45/021

(57) ABSTRACT

A system and method to configure a high-speed interconnection network between devices coupled to a host is disclosed. A bus having a plurality of lanes is coupled to the host. Each of the devices are coupled to one or more of the lanes of the bus allowing communication to the host. Each of the devices is coupled to two neighboring devices via cables coupled to high-speed input output ports to form a ring interconnection between the devices. The devices are identified by designating a first device and sending packets to the other devices to identify the other devices to allow high speed data traffic to be sent between the devices on the ring interconnection.

### TECHNICAL FIELD

The present disclosure relates generally to high speed connections between cores in a fractal core based architectures. More specifically, the present disclosure relates to discovery of devices for establishing a high speed ring interconnection to allow high speed data flow between devices.

### BACKGROUND

As computational tasks become more demanding, computers have evolved from general purpose CPUs to specialized processor units such as GPUs that were found to be more optimal for certain applications such as artificial intelligence (AI). As hardware has increased in capability, the requirements for applications have also increased. For example, new types of quantum secure encryption have been proposed, such as fully homomorphic encryption (FHE). FHE allows computations on ciphertext without having to perform decryption. This allows delegation of sensitive data analysis computations on encrypted data. FHE is based on a quantum secure scheme for the LWE (learning with errors) problem. The FHE allows computations such as Boolean operations, Integer arithmetic operations, and floating-point arithmetic operations on ciphertext without decryption. Thus, sensitive data analysis (computations) may be performed on encrypted data without ever decrypting the data.

In theory, privacy could actually be accomplished by using fully homomorphic encryption (FHE) approaches, but this approach is too computationally cumbersome for conventional hardware such as graphic processor units (GPU)s. One solution is computer systems with specialized devices that have multiple homogeneous cores that can more efficiently perform computations required by FHE than convention GPUs. A system that has vast numbers of such devices can be used to perform computational intense operations such as FHE computations.

There is a need for a connection fabric for such multi-core ASIC devices, which are central to modern artificial intelligence and Fully Homomorphic Encryption (FHE) systems. These systems typically comprise of an array of cores functioning as a data flow machine. The flexibility of such data flow systems allows for an increase in computational power proportional to the number of cores available. To achieve substantial computational power, multiple arrays of these chips are interconnected using high-speed input/output (HSIO) networks, forming a computational fabric consisting of tens of chips and thousands of cores. This fabric can execute large operational graphs. The topology of the chip arrays is determined by connections through the external HSIO network. Each device or (devices on a card) are connected using high-speed interconnect cables, such as copper or optical cables in a data center rack. Data flows through these interconnect cables, forming the topology of connections within the compute fabric.

In a computational system with such multi-core devices, a host communicates with multiple devices through lanes of a Peripheral Component Interconnect Express (PCIe) bus. One or more lanes on the PCIe bus is assigned to exclusively to each device to allow communication with the host. The devices are assigned PCIe enumeration numbers based on the lane or lanes of the bus they are connected to.

Each of the devices also include two HSIO ports (CI1 and CI0). A high speed cable may be used to connect the HSIO ports of neighboring devices to allow a ring network for data exchange between devices. However, typically, a HSIO connection will not follow PCIe enumeration order. Furthermore, in a system that may include multiple hosts, each connected to a set of devices, the devices form a larger computational fabric where connection topology of devices associated with different hosts is more complicated. Thus, it is a challenge to easily establish the high speed ring interconnection to allow data exchange between devices.

Thus, there is a need for a method to configure a high speed interconnection between devices that may be dynamically configured. There is a further need for a flexible interconnection system that allows devices to be added or removed.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, an example computer system is disclosed. The computer system includes a host and a bus having lanes coupled to the host. Each of a plurality of devices is coupled to one or more of the lanes of the bus allowing communication to the host. Each of the devices is coupled to two neighboring devices via cables coupled to high speed input output ports to form a ring interconnection between the devices. Each of the devices are identified by identifying a first device and sending packets to each device to identify the other devices to allow high speed data traffic between the devices on the ring interconnection.

A further implementation of the example system is where each of the devices includes a plurality of processing cores coupled to a local device network. Another implementation is where each of the devices is one of an array of processing cores, a FPGA, an ASIC, or a GPU card. Another implementation is where the bus is a PCIe compliant bus. Another implementation is where the first device is identified as a device of the plurality of devices with the lowest PCIe bus number. Another implementation is where the host executes an identification routine that identifies the devices by updating corresponding routing tables for each of the identified devices. Each of the routing tables includes an entry for each of the plurality of devices and a corresponding high speed port. Another implementation is where the host re-executes the identification routine when a device is added or a device is removed from the plurality of devices. Another implementation is where the first identified device or a second identified device sends a packet to identify a third device. The entry for third device in each of the routing tables of the unidentified devices is configured as local and each of the other entries of the corresponding routing tables for each of the unidentified devices is configured as invalid. Another implementation is where after all devices are identified, the identification routine populates each of the invalid entries of the routing tables with a high speed port corresponding to the closest device for each listed device. Another implementation is where the example system further includes another host and another bus having lanes coupled to the another host. Each of another plurality of devices is coupled to one or more of the lanes of the another bus allowing communication to the another host. Each of the devices of the another plurality of devices is coupled to two neighboring devices via cables coupled to high speed input output ports. The another plurality of devices is part of the ring interconnection between the plurality of devices.

Another example method for configuring a high-speed ring network between devices coupled via a bus to a host is disclosed. The devices include high speed ports coupled to neighboring devices via cables. One of the devices is identified as a first device. An entry of a routing table of the identified first device is modified to identify a high-speed port of the first device connected to a neighboring second device. A packet is sent through a ring network to the second device. The second device is identified. An entry of a routing table of the identified second device is modified to identify a high-speed port of the second device connected to a third neighboring device.

A further implementation of the example system is where the devices comprise one of a device with a plurality of processing cores coupled to a local device network, a FPGA, an ASIC, or a GPU card. Another implementation is where the bus is a PCIe compliant bus and where the first device is identified as the device with the lowest PCIe bus number. Another implementation is where the host executes a routine to identify the first device, modify the entry of the routing table of the first device, send the packet, identify the second device, and update the routing table of the second device. Another implementation is where the host re-executes the routine when a device is added or a device is removed from the plurality of devices. Another implementation is where each of the devices include a routing table having entries corresponding to each of the plurality of devices. The example method includes updating the entries of all routing tables of all unidentified devices with an invalid entry. Another implementation is where the example method includes configuring an entry of each of the routing tables corresponding to the identified second device as local. Another implementation is where the example method includes sending a packet through the ring network to the third neighboring device and identifying the third neighboring device. The method includes modifying an entry of a routing table of the identified third neighboring device to identify a high-speed port of the third device connected to a fourth neighboring device. Another implementation is where either the first device sends the packet to the third neighboring device, or the second device sends the packet to the third neighboring device. Another implementation is where the example method includes repeating the sending, identifying and modifying until all devices of the plurality of devices are identified. The example method also includes configuring all invalid entries in all of the routing tables according to a high speed port of the corresponding device closest to the device corresponding to the entry.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be better understood from the following description of exemplary embodiments together with reference to the accompanying drawings, in which:

FIG. 1A is a diagram of a chip having four dies each having multiple processing cores;

FIG. 1B is a simplified diagram of one of the dies on the chip shown in FIG. 1A;

FIG. 2A is a block diagram of part of the array of cores in the die in FIG. 1B;

FIG. 2B is a three-dimensional view of the array of cores in the die in FIG. 1B;

FIG. 3 is an example reconfigurable arithmetic engine configuration of one of the cores in the core array in FIG. 2A;

FIG. 4 is a diagram of configurations of the array of cores in FIG. 2A as either a RISC-V or a specialized ALU internal module;

FIG. 5 is a diagram of a computer system having peripheral devices with a high speed interconnection connecting all of the peripheral devices;

FIG. 6 is a diagram of a computer system incorporating several computer systems each having peripheral devices and a high speed interconnection connecting all of the peripheral devices;

FIG. 7 is an example routing table used by an example device to send packets on the high speed interconnection in a computer system such as the computer systems in FIGS. 5-6;

FIGS. 8A-8E are charts showing the modifications of routing tables in the devices modified by the example routine to establish the high speed interconnection in the system in FIG. 5;

FIG. 9 is a flow diagram of an example routine to identify devices in establishing the high speed interconnection; and

FIG. 10 is a flow diagram of another example routine to identify devices in establishing the high speed interconnection.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

This present disclosure relates to connection fabric of multi-core application specific integrated circuit (ASIC) devices based on a homogeneous array of cores. These systems typically comprise of an array of cores functioning as a data flow machine for high computational demand applications such as FHE encryption, machine learning, deep learning, and artificial intelligence. The flexibility of such data flow systems allows for an increase in computational power proportional to the number of cores available in the array. To achieve substantial computational power, such devices are interconnected using high-speed input/output (HSIO) networks, forming a computational fabric consisting of tens of chips and thousands of cores.

The topology of the chip arrays is determined by connections through the external HSIO network. Each device or (devices on a card) are connected using high-speed interconnect cables, such as copper or optical cables in a data center rack. The devices typically include with the array of homogeneous cores. Data flows through these interconnect cables and forms the topology of connections within the compute fabric. The example system provides a two-channel interface for interconnect connections to two neighboring devices. The devices are enumerated immediately as they are connected to a host via the lanes of a PCIe bus. An example routine is designed to detect which specific devices (already enumerated on the PCIe bus) are connected to other devices in a ring of HSIO connections. This allows rapid data flow between specific devices through the HSIO network.

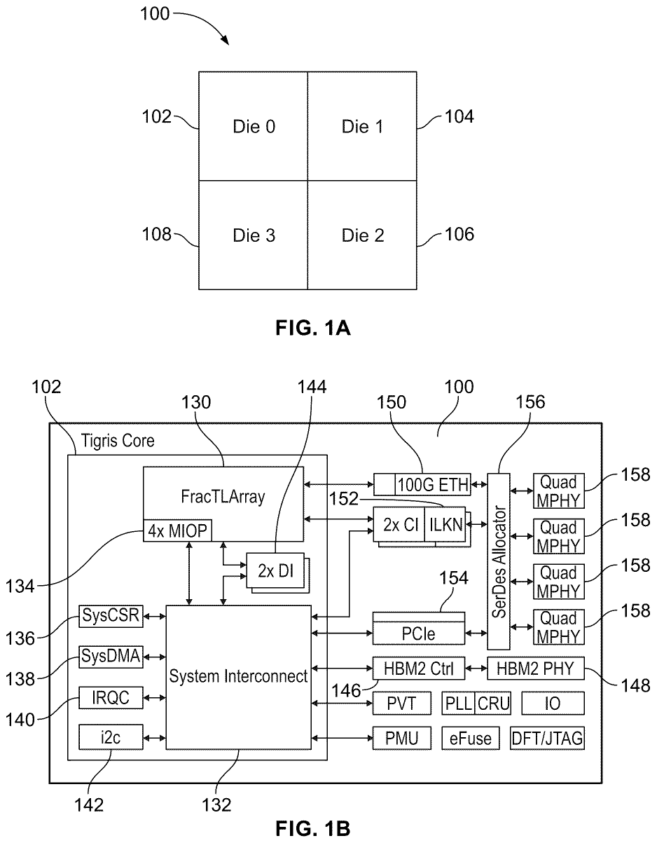

FIG. 1A shows an example chip 100 that is subdivided into four identical dies 102, 104, 106, and 108. Each of the dies 102, 104, 106, and 108 include multiple processor cores, support circuits, serial interconnections and serial data control subsystems. For example, the dies 102, 104, 106, and 108 may each have 4,096 processing cores as well as SERDES interconnection lanes to support different communication protocols. There are die to die parallel connections between the dies 102, 104, 106 and 108. Thus, each of the dies 102, 104, 106, and 108 in this example are interconnected by Interlaken connections. The chip 100 is designed to allow one, two or all four of the dies 102, 104, 106, and 108 to be used. The pins on a package related to un-used dies are left unconnected in the package or the board. The dies are scalable as additional chips identical to the chip 100 may be implemented in a device or a circuit board. In this example, a single communication port such as an Ethernet port is provided for the chip 100. Of course, other ports may be provided, such as one or more ports for each die.

FIG. 1B is a block diagram of one example of the die 102. The die 102 includes a fractal array 130 of processing cores. The processing cores in the fractal array 130 are interconnected with each other via a system interconnect 132. The entire array of cores 130 serves as the major processing engine of the die 102 and the chip 100. In this example, there are 4096 cores in the fractal array 130 that are organized in a grid.

The system interconnection 132 is coupled to a series of memory input/output processors (MIOP) 134. The system interconnection 132 is coupled to a control status register (CSR) 136, a direct memory access (DMA) 138, an interrupt controller (IRQC) 140, an I2C bus controller 142, and two die to die interconnections 144. The two die to die interconnections 144 allow communication between the array of processing cores 130 of the die 102 and the two neighboring dies 104 and 108 in FIG. 1A.

The chip includes a high bandwidth memory controller 146 coupled to a high bandwidth memory 148 that constitute an external memory sub-system. The chip also includes an Ethernet controller system 150, an Interlaken controller system 152, and a PCIe controller system 154 for external communications. In this example each of the controller systems 150, 152, and 154 have a media access controller, a physical coding sublayer (PCS) and an input for data to and from the cores. Each controller of the respective communication protocol systems 150, 152, and 154 interfaces with the cores to provide data in the respective communication protocol. In this example, the Interlaken controller system 152 has two Interlaken controllers and respective channels. A SERDES allocator 156 allows allocation of SERDES lines through quad M-PHY units 158 to the communication systems 150, 152 and 154. Each of the controllers of the communication systems 150, 152, and 154 may access the high bandwidth memory 148.

In this example, the array 130 of directly interconnected cores are organized in tiles with 16 cores in each tile. The array 130 functions as a memory network on chip by having a high-bandwidth interconnect for routing data streams between the cores and the external DRAM through memory IO processors (MIOP) 134 and the high bandwidth memory controller 146. The array 130 functions as a link network on chip interconnection for supporting communication between distant cores including chip-to-chip communication through an “Array of Chips” Bridge module. The array 130 has an error reporter function that captures and filters fatal error messages from all components of array 130.

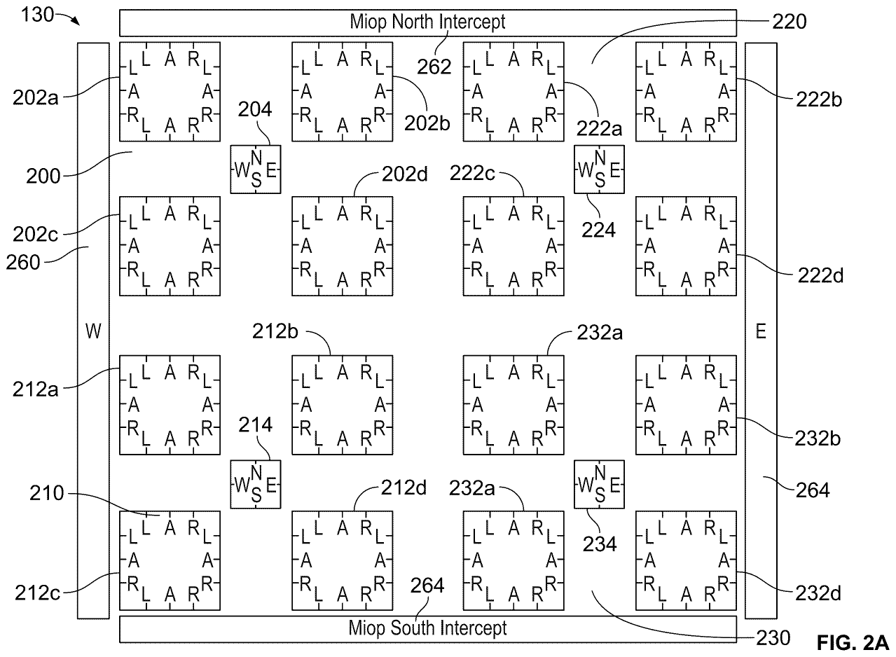

FIG. 2A is a detailed diagram of the array of cores 130 in FIG. 1B. FIG. 2B is a three-dimensional image of the array of cores 130 in FIG. 2A. The array of cores 130 is organized into four core clusters such as the clusters 200, 210, 220, and 230 shown in FIG. 2A. For example, the cluster 200 includes cores 202a, 202b, 202c, and 202d. Each of the four cores in each cluster 200 such as cores 202a, 202b, 202c, and 202d are coupled together by a router 204. FIG. 2B shows other clusters 210, 220, and 230 with corresponding cores 212a-212d, 222a-222d and 232a-232d and corresponding routers 214, 224, and 234.

As may be seen specifically in FIG. 2B, in this example, each of the cores 202a, 202b, 202c, and 202d has up to four sets of three interconnections [L, A, R]. For example, a core in the center of the array such as the core 202d includes four sets of interconnections 240, 242, 244, and 246 each connected to one of four neighboring cores. Thus, core 202b is connected to the core 202d via the interconnections 240, core 222c is connected to the core 202d via the interconnections 242, core 212b is connected to the core 202d via the interconnections 244, and core 202c is connected to the core 202d via the interconnectors 246. A separate connector 248 is coupled to the wire router 204 of the cluster 200. Thus, each core in the middle of the array has four sets of interconnections, while border cores such as the core 202c only have three sets of interconnections 250, 252, and 246 that are connected to respective cores 202a, 212a, and 202d.

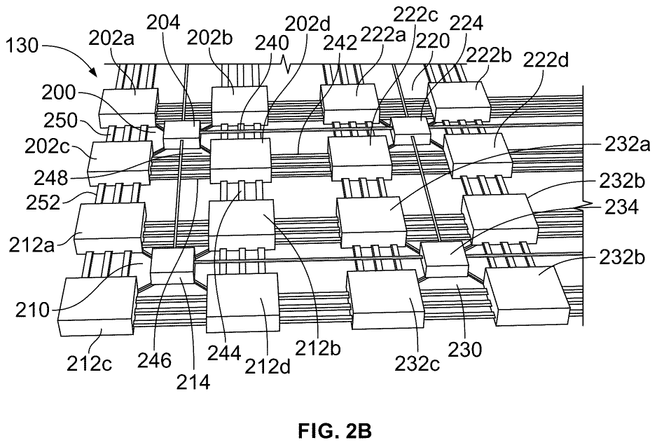

In order to configure the cores of the example array 130 in FIG. 2A, the inputs of certain blocks may be changed to configure blocks for one of the three different function blocks. The functions may be configured by simply changing the inputs of the processing cores. FIG. 3 shows a block diagram of an example processing core 300 that includes a reconfigurable arithmetic engine (RAE) 310. The RAE 310 may be configured and reconfigured to perform relevant mathematical routines such as matrix multiplications, point wise multiplication and nonlinear functions, such as layer normalization and a Softmax function, required in private LLM. The RAE 310 includes input reorder queues, a multiplier shifter-combiner network, an accumulator and logic circuits. The RAE 310 operates in several modes, such as operating as an ALU, and include a number of floating point and integer arithmetic modes, logical manipulation modes (Boolean logic and shift/rotate), conditional operations, and format conversion. The RAE 310 includes three inputs 312, 314, and 316 and three outputs 322, 324, and 326. The RAE 310 receives the output data from a program executed by another RAE 330 and output data from another program executed by another RAE 332. An aggregator (AGG) 334 provides an output of aggregated data from different sources to the RAE 310. A memory read output 336 and a memory write output 338 also provide data to the RAE 310. The memory outputs 436 and 438 provide access to a memory such as an SRAM that stores operand data, and optionally may also store configurations or other instructions for the RAE 310.

Each of the output data of the RAE 330, RAE 332, aggregator 334, memory read output 336 and the memory write output 338 are provided as inputs to three multiplexers 342, 344, and 346. The outputs of the respective multiplexers 342, 344, and 346 are coupled to the respective inputs 312, 314, and 316 of the RAE 310.

RISC-V for Legacy code is supported by configuring multiple cores under software control. This may be used to produce software GPUs or other types of cores from the multiple cores. The processing cores such as the FracTLcores® available from Cornami in this example are an efficient set of transistors for streaming data driven workloads, with a programming scheduler such as the TruStream programming scheduler offered by Cornami and memory, created from a set of RAE Cores. In this example, the FracTLcores® can scale up to 64 million cores across chips and systems at near linear scale. The use of the architecture of processing cores results in reduction in processing cost. The cores may employ a Data-Flow Programming Model resulting in a 5× reduction in processing cost. A Data-Defining-Function Computation for the cores may result in a 6× reduction in processing cost. A data Read/Write with a Tensor pattern applied to the cores may result in a 6× reduction in processing cost.

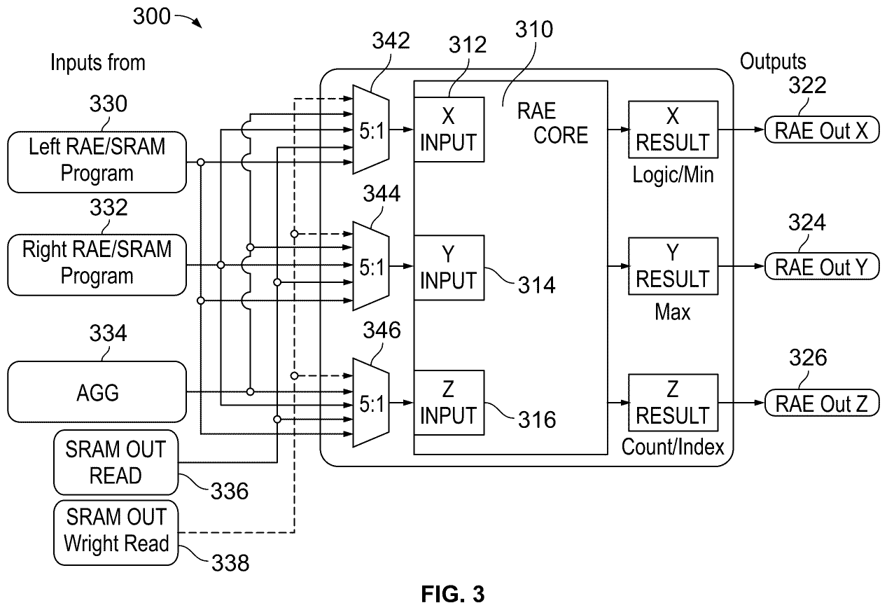

FIG. 4 is a diagram of four configurations 410, 420, 430, and 440 of the array of cores in FIG. 2B as either a RISC-V processor or a specialized ALU internal module. The configurations 410, 420, 430, and 440 can dynamically switch from one type to the other by reconfiguring some or all of the computational cores in the configurations. The first configuration 410 is a set of cores configured as a full RISC processor with associated SRAM able to execute traditional Control Flow programs as a function representing the computation within a dataflow node. In this example, the RISC processor includes sixteen separate cores 412. Another configuration 420 is sixteen independently reconfigurable and programmable ALUs, that are each cores 422. Each of the cores 422 have associated SRAM supporting multiple simultaneous integer and floating point computations of up to 128-bits. The configuration 420 thus is a set of cores that are configured as individual FracTLcores®. The configuration 430 includes one or more RISC cores 432 that are a set of sixteen cores in this example. The RISC core 532 can have additional individual or multiple cores 434 incorporated within them to accelerate specific RISC functions. Alternatively, the additional cores 434 may be designated for data path/arithmetic acceleration, enhancing ALU performance.

Thus, to implement a standard 64 bit RISC processor such as the RISC-V processor in this example, sixteen cores are configured to become the RISC-V. Optional additional cores may be added to the configuration to provide hardware acceleration to math operations performed by the RISC. For example, a normal RISC processor does not have hardware to perform a cosine function. Thus, an additional core may be added and configured to perform a hardware cosine operation. This enhances the ISA instruction set of the RISC processor by adding the hardware accelerated cosine function that may be accessed by the RISC processor. The configuration 440 has a set of cores that is configured into two individual groupings of cores configured as RISC processors 442 and cores that are configured as ALUs (e.g., FracTLcores®) 444.

In this example, devices in a computing system may constitute processors that are configured from the array of cores in FIG. 1B. Each array of cores may be organized in processors in one of the configurations in FIG. 4 or other configurations. Such devices are typically connected to a host via bus. The devices may also be connected to each via a separate high-speed input/output (HSIO) network to allow high speed data flow between the devices. Typically, a HSIO connection will not follow PCIe enumeration order and thus the example routine provides a method for setting up the HSIO network between devices connected independent of enumeration order.

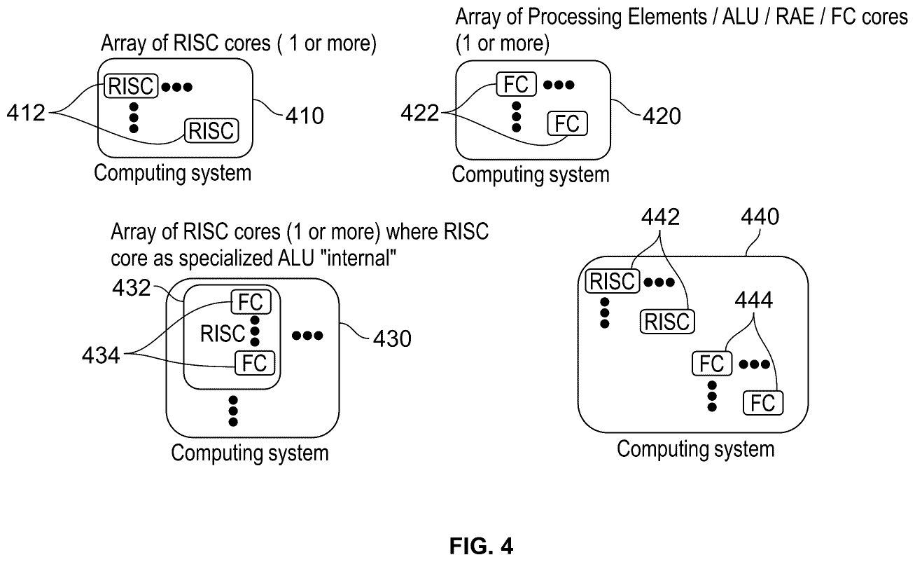

FIG. 5 shows a computer system 500 that includes a host 510 coupled to a peripheral component interconnect express (PCIe) bus 512. The system 500 includes a series of devices 520, 522, 524, 526, 528, 530, and 532. In this example, each of the devices 520, 522, 524, 526, 528, 530, and 532 are peripherals having an array of cores with an architecture similar to that shown in FIGS. 1B and 2A. In this example, each device 520, 522, 524, 526, 528, 530, and 532 has an in-chip network for communication between cores on the device. Each of the devices 520, 522, 524, 526, 528, 530, and 532 communicate with the host 510 via the PCIe bus 512. Thus, the host 510 allocates lanes of the PCIe bus 512 to each of the devices 520, 522, 524, 526, 528, 530, and 532. Although the devices 520, 522, 524, 526, 528, 530, and 532 are described in FIGS. 1B and 2B, it is to be understood that any peripheral device that is PCIe compatible and allows data flow communication through a high speed interconnection may be one of the devices 520, 522, 524, 526, 528, 530, and 532. For example, the devices may include any networked devices that need high speed connection to each such as processor cards using the architectures in FIG. 4, ASICs, FPGA based devices, GPU cards, or other programmable intelligent devices that may be network nodes. The number of devices may vary between one device and the maximum number of devices supported by the PCIe bus 512.

Each device 520, 522, 524, 526, 528, 530, and 532 has a CI0 high speed port 540 and a CI1 high speed port 542 that allows connection of the devices in a ring interconnection 550 devices. Each device is connected to the two physically neighboring device in the ring via a two way cable. For example, the CI0 port 540 of the device 520 is connected with the CI1 port of the device 530 while the CI1 port 542 of the device 520 is connected with the CI0 port of the device 522. The cables that comprise the ring interconnection 550 constitutes the HSIO connection between the devices 520, 522, 524, 526, 528, 530, and 532 to allow high speed communication of data. In this example, each of the devices 520, 522, 524, 526, 528, 530, and 532 can perform data operations such as matrix multiplication for an encryption application such as FHE.

Each device 520, 522, 524, 526, 528, 530, and 532 is assigned a PCIe bus number by the host based on configurations of a basic input output system (BIOS) executed during start up of the host 510. The devices 520, 522, 524, 526, 528, 530, and 532 are connected randomly and thus the devices 520, 522, 524, 526, 528, 530, and 532 are not physically connected in order of their respective PCIe bus number. For example, the device 522 is bus number 1 while the neighboring connected devices 520 and 524 have the corresponding bus numbers 7 and 3. Each device is also numbered based on their physical location on the ring 550. As will be explained, the first PCIe bus number corresponds to the first device number. In this example, the device 522 is both bus number 1 and Device 1. The next neighboring device 524 is Device 2, but has PCIe bus number 3. Thus, the PCIe bus numbers are not consecutive in relation to the relative physical position of the devices 520, 522, 524, 526, 528, 530, and 532 connected to the PCIe bus 512. Since the devices 520, 522, 524, 526, 528, 530, and 532 are not consecutively positioned relative to their bus numbers, the ring 550 formed by the high-speed cable can only be used by each device 520, 522, 524, 526, 528, 530, and 532 discovering all the other devices to properly route data through the high speed cable ring interconnection 550.

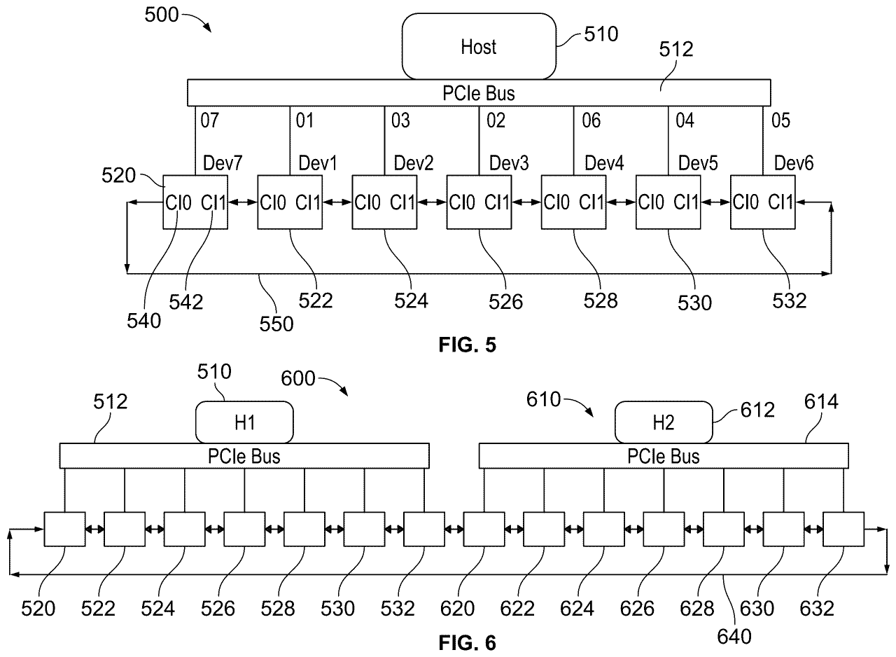

Furthermore, in a rack of connections, there may be multiple hosts, and a bigger computational fabric may be formed where connection topology of devices is more complicated. FIG. 6 shows a computer system architecture 600 including the system 500 and a second system 610 similar to the system 500 in FIG. 1, each with a separate host. Thus, in this example the second system 610 includes a host 612 connected to a PCIe bus 614. The host 612 may communicate to devices with the core architecture described herein via the PCIe bus 614. Devices 620, 622, 624, 626, 628, 630, and 632 coupled to the host 612 via the PCIe bus 614. In this example the devices 520, 522, 524, 526, 528, 530, and 532 of the system 500 and the devices 620, 622, 624, 626, 628, 630, and 632 of the system 610 are connected via a HSIO network 640 that consists of high speed cables connecting the CI0 and CI1 ports of each of the devices 520, 522, 524, 526, 528, 530, 532, 620, 622, 624, 626, 628, 630, and 632 to their neighboring devices in a ring configuration.

An example routine allows the configuration of the HSIO network 640 to allow data packets to be sent between the HSIO ports of each device via the HSIO network 640 to allow data communication between devices 520, 522, 524, 526, 528, 530, 532, 620, 622, 624, 626, 628, 630, and 632.

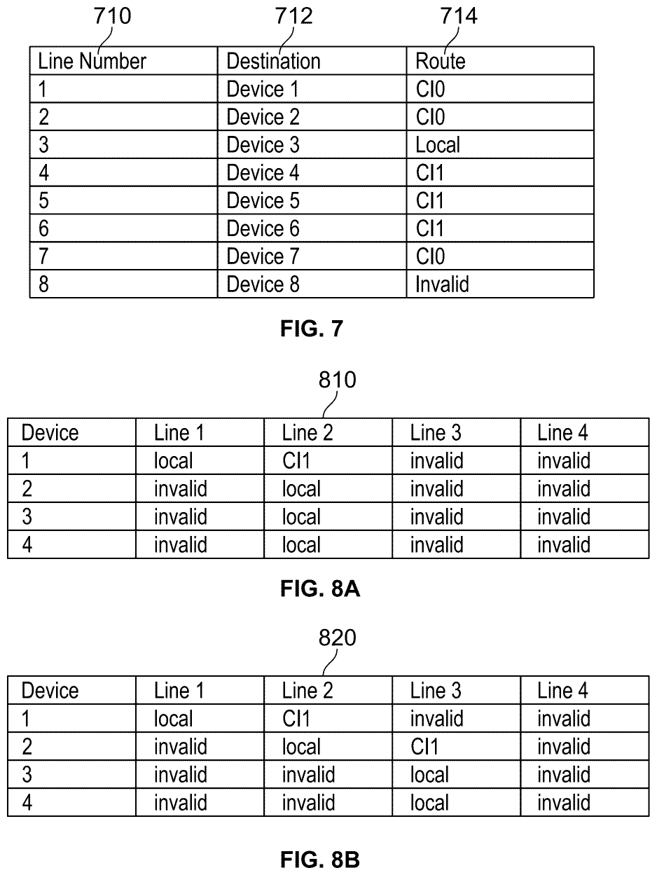

FIG. 7 shows an example AOC routing table 700 for data communication to devices connected in the ring 550 for the example device 526 in FIG. 5 that has been assigned a PCIe bus number 2. The example routing table 700 includes information on the other linked devices 520, 522, 524, 528, 530, and 532 on the ring 550 to allow transmission of data to and from the device 526. The table 700 includes a line number column 710, a destination column 712, and a route column 714. In this example, there are eight line numbers as there are a maximum of eight devices that may communicate with the host via the PCIe bus 514. The first two lines of the table 700 are for the first and second devices 522 and 524. The corresponding route is through the CI0 port of the device 526 as these devices are closer in proximity to the CI0 port. The third row of the table 700 is designated by the local device network, since the third row corresponds to the device 524. The next three rows represent the other devices 528, 530, and 532. For these devices, data is routed through the CI1 port of the device 524. The second to last row represents the device 530. For device 530, data is routed through the CI0 port of the device 524. The last line of the table 700 is for an eighth device. In this example, the last line is assigned an invalid entry as there are only seven devices on the ring 550.

The example ring interconnection 550 in FIG. 5 sends packets from one device to another via the HSIO cables connecting the device to the two neighboring devices. The routine is based on the dynamic configuration of routing table such as the table 700 in FIG. 7 of the array of chips (AOC) in each device 520, 522, 524, 526, 528, 530, and 532 through the respective HSIO ports (CI1 and CI0). This routine enables efficient device connection topology discovery to allow the devices 520, 522, 524, 526, 528, 530, and 532 to exchange data on the high-speed ring interconnection 550. The AOC routing table 700 is configured to route the data packets in run time to the correct destination, either to the in-chip network (local) on a device or outside the device through either the CI1 or CI0 port.

In this example, the devices 520, 522, 524, 526, 528, 530, and 532 are initially coupled to different lanes of the PCIe bus 512. The devices 520, 522, 524, 526, 528, 530, and 532 are assigned a bus number. The example topology discovery routine starts with picking one of the devices 520, 522, 524, 526, 528, 530, and 532, which is enumerated as an “identified” device.” The example topology routine chooses the device with the smallest PCIe bus number. Thus, assuming there are N number of devices in a ring, there may be two different versions of the routine to set up the devices for high-speed data flow.

A first version of the routine starts with the device with the lowest PCIe bus number sending a packet to the next device and each identified device in turn sending a packet to identify the next device. In this example, the first version of the routine starts with the device with the lowest PCIe bus numbers. At this point the device numbers (which are assigned by the host 510) are unknown as the connection order of the devices 520-532 is unknown. The devices will have to follow an incremental order once the connection topology is discovered as a result of running the example routine to establish the high-speed interconnection network 550. The routing tables for each of the devices have not fully populated. The device with the lowest PCIe bus number is thus identified as Device 1 in the first line of each routing table. Each other device is identified by probe packages sent by the first identified device. Each device includes a routing table such as that shown in FIG. 7 that is programmed by the host 510. The host 510 assigns the numbers for the devices and programs the routing table for each device so that when each device receives a packet with a device number, they can process the received packet according to the routing table that is programmed by the host 510 according to the accurate connection topology determined by the example routine.

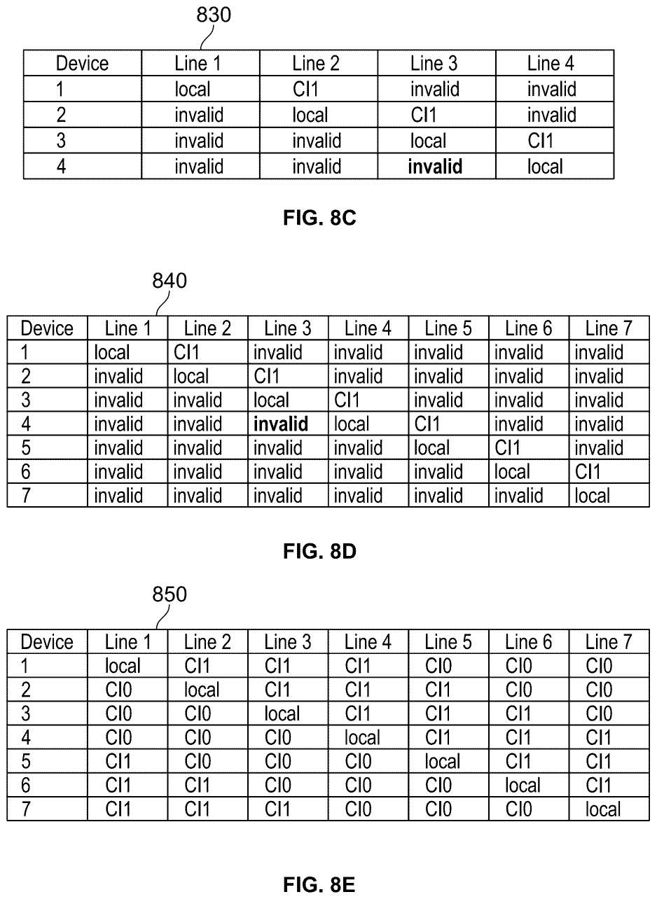

FIG. 8A shows a first summary chart 810 of the lines of each of the routing tables for each of the devices after the initial configuration of Device 1 (device 522). The rows in the summary chart 810 are the routing tables for the respective devices and the columns list what is written on each line. The summary chart 810 only includes a summary of the routing tables for Devices 1-4 for simplicity of explanation. Thus, after Device 2 is identified, the line 1 for the routing table for Device 1 is configured as local. The lines for the routing devices of the other unidentified devices are configured as “invalid.” The line 2 for the only known device, Device 1 is written as CI1 and line 2 of the unknown Devices 2-4 is written as local. The other lines of the unknown devices are configured as “invalid.”

Device 1 (in this example device 522) sends a data package to the device (k+1) (in this example Device 2, device 524) to identify the device. The line number (k+1) (in this example line 2 corresponding to Device 2) of the routing table of Device 1 is configured to the port CI1 in the initial configuration. The line number (k+1) of all the routing tables of the unidentified devices (Devices 2-7) are configured to “local.” The other line numbers of all the routing tables of the unidentified devices are configured as “invalid.” Then Device 1 sends a packet to device (k+1) based on the now configured line 2 of the routing table. Only the device (k+1) (Device 2) that receives the package is now identified. All other devices will time out as they do not receive the package.

Thus, after Device 2 (device 524) is discovered, k is now 2. Thus, the line number (k+1) (in this example line 3 corresponding to Device 3) of the routing table of Device 2 is configured to the port CI1. The line number (k+1, line 3) of all the routing tables of unidentified devices (Devices 3-7) are configured to “local.” The other line numbers of the unidentified devices are configured to “invalid.” A second chart 820 in FIG. 8B shows a summary of the lines of the routing tables after Device 2 is discovered. The second chart 820 shows that line 3 of Device 2 is configured as CI1. Line 3 of the routing tables of the unidentified devices (Devices 3-7) are configured as “local.” The other lines such as line 4 of the unidentified devices are configured as “invalid.”

Device 2 (device 524) then sends a packet to device (k+1) (Device 3) based on the now configured line 3 of the routing table of Device 2. Once Device 2 sends the packet, only the device (k+1) (Device 3) that receives the package is now identified. All other devices will time out as they do not receive the package. The line number k+1 (now 4) is configured to port CI1 for the routing table for the new identified Device 3.

FIG. 8C shows a summary chart 830 of the lines of the routing tables after the Device 3 is discovered. As shown by the chart 830, the line 3 of the unknown device (Device 4) has been changed from “local” to “invalid.” Line 4 of the unknown devices (Devices 4-7) is configured as “local.”

The process is repeated until the highest-numbered device N (in this example device 520) is discovered. Thus, this process continues until a packet is sent to Device 7 from Device 6. After Device 7 is identified all of the devices coupled to the PCIe bus are identified in this example. FIG. 8D shows a summary chart 840 of the routing tables of the devices after Device 7 is identified. As chart 840 shows, all of the lines corresponding to each device in the routing tables have been configured as local. All of the lines for the next device have been configured as CI1 in each of the routing tables. All other lines in the routing tables have been configured as invalid.

After all of the devices are identified, the routine goes through each of the invalid line number entries for each routing table. Thus, m =1 . . . N for invalid line number entries in each routing table of each “device k.” The routine determines whether the distance to the right is less than the distance to the left. If the distance to the right is less, than the invalid entry is configured to CI1. If the distance to the right is greater than the distance to the left, the invalid entry is configured as CI0. The distance to the right is determined by k−m (mod N) and the distance to the left is determined by m−k (mod N). For example, if N is 7, for device k=3 and the number of invalid entries, the distance to the right is m=5, (k−m=−2), −2 in Mod 7 is +5, and the distance to the left is (m−k=2), so (device k), (line 5) is CI1 (2<5). As another example, for Device 2 (k=2), and line 6 (m=6). The distance right is determined as 6−2=4, and the distance left is determined as 2−6=−4, and −4 in Mod 7 is +3. Since Distance Left of 3 <Distance Right of 4, line 6 is configured as CI0.

In this example, lines 2-4 of the routine table for Device 1 would be configured to CI1 as the distance right for each of the devices in the lines 2-4 are shorter than the distance left. Lines 5-7 would be configured to CI0 as the distance left for each of the devices in the lines 5-7 are shorter than the distance right. FIG. 8E is a chart 850 of the entries in each of the routing tables for the devices after the routine is complete.

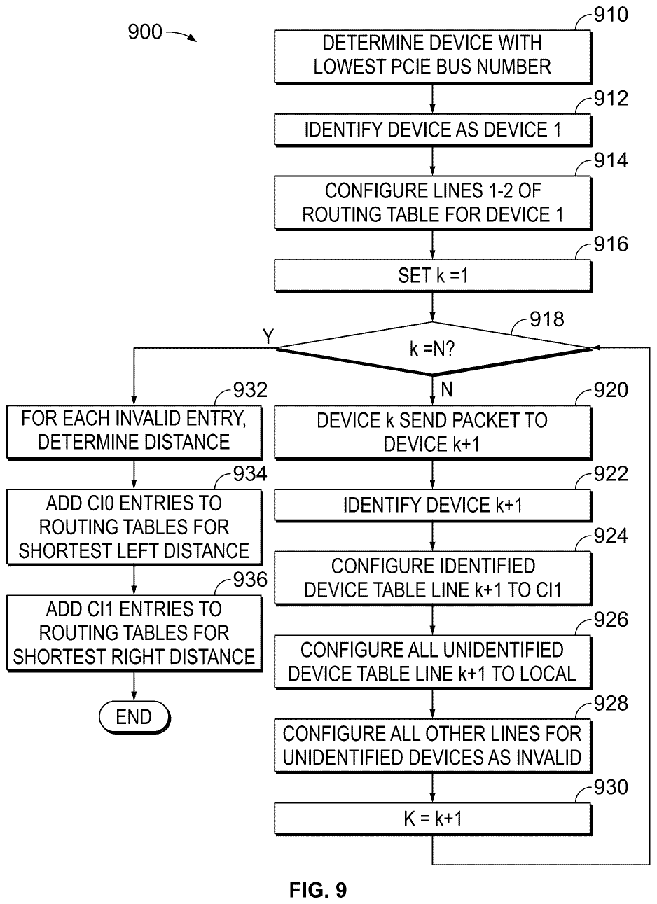

FIG. 9 is a flow diagram 900 of the first example routine for identifying devices. First the routine determines the device with the lowest PCIe bus number (910). The determined device is identified as Device 1 with the associated line 1 in the routing table (912). Line 1 of the routing table for Device 1 is configured as local and line 2 is set as CI1 (914). The number corresponding to the next device, k is set to 1 (916). The routine then determines whether k is the last device (918) e.g., whether k=N, where N is the total number of devices.

If the k device is not the last device (918), the routine controls the k device to send a packet to the next device k+1 (920). All other devices receiving the packet will time out, the k+1 device will receive the packet and will be identified (922). The line k+1 of the newly identified device is then configured to CI1 (924). The line k+1 of all unidentified devices is configured to “local” (926). For all unidentified devices all other lines except k+1 are configured to “invalid” (928). k is then incremented by one (930) and the routine loops back to step 916.

If the newly identified device k is the last device N (916), the routine will review each “invalid” entry for all lines in the routing tables and determine the distance to the corresponding devices (932). The routine then updates all the invalid entries in the routing tables that are closer to the leftmost port (the CI0 port) of the corresponding device to CI0 (934). The routine then updates all invalid entries in the routing tables that are closer to the rightmost port (the CI1 port) of the corresponding device to CI1 (936). The routine then ends.

A second version of the example routine uses probe packages that are all initiated by Device 1. The device with the lowest PCIe bus number is thus identified as Device 1 in the first line of the table. The routing table of the Device 1 (522 in this example) is configured to send a packet to Device 2 (524 in this example) by designating the route column as the CI1 port in the second line representing Device 2. Line 2 of the routing table for all other non-identified devices have the route column configured as “local.” All other lines in the routing tables that exceed the number of devices e.g., those without a corresponding device are designated as “invalid.”

Device 2 (524 in this example) is then discovered by Device 1 sending a packet to Device 2 over the CI1 port based on the routing table in Device 1. Device 2 (the one immediately connected to the CI1 port/right port of Device 1) receives this packet, and identifies itself as the second device in the sequence.

The process is repeated for each device connected to each other: k=2 . . . N. Thus, Device 1 sends a packet to the next unidentified device k+1 (Device 3). The line number (k+1) of the AOC routing table of the newly identified device k is set to CI1 for the preceding device (Device 3). The line number (k+1) for the AOC tables of the other devices (except for the identified devices) is set up as “local.” All other lines are configured as invalid for the unidentified devices. Only the device immediately connected to CI1 will be identified as device (k+1). This process repeats until the highest-numbered device (N) in the ring is discovered.

Thus, in this example Device 2 (524) will receive the packet from Device 1. The routing table for Device 2 includes the second line for Device 2, which was previously configured as local. The next device neighboring Device 2 is Device 3 (526). The third line is used for Device 3 and the route is set for CI1 in the Device 1, which sends a packet to Device 3. The third lines of the routing tables for unidentified devices, e.g., Devices 4-7 (528, 530, 532, and 520) are configured as local. The other lines for the unidentified devices will be configured as invalid. Device 1 (522) will then send a packet to Device 3 and routine will repeat for Device 3.

Thus, in this example Device 3 (526) will receive the packet. The routing table for Device 2 includes a first line that is for Device 1. The routing table for Device 3 includes the third line for Device 3, which was previously configured as local. The next device neighboring Device 3 is Device 4 (528). The fourth line is used for Device 4 and the route is set for CI1. The fourth lines of the routing tables for unidentified devices, e.g., Devices 5-7 (530, 532, and 520) are configured as local. The fourth line of identified devices e.g., Devices 1 and 2 (522 and 524) will be populated by copying the entry on the fourth line from the routing table of Device 3 (e.g., CI1). Device 1 (522) will then send a packet to Device 4 and the routine will repeat for Device 4. Thus, gradually, the routing tables of all the devices are populated line by line through each identified/assigned device in sequence.

Once Device 7 (520) is discovered by Device 1 (522), the routine ends as all devices are identified. In this example, the routine will add CI0 and CI1 entries to the table entries based on the distance to the device as explained above.

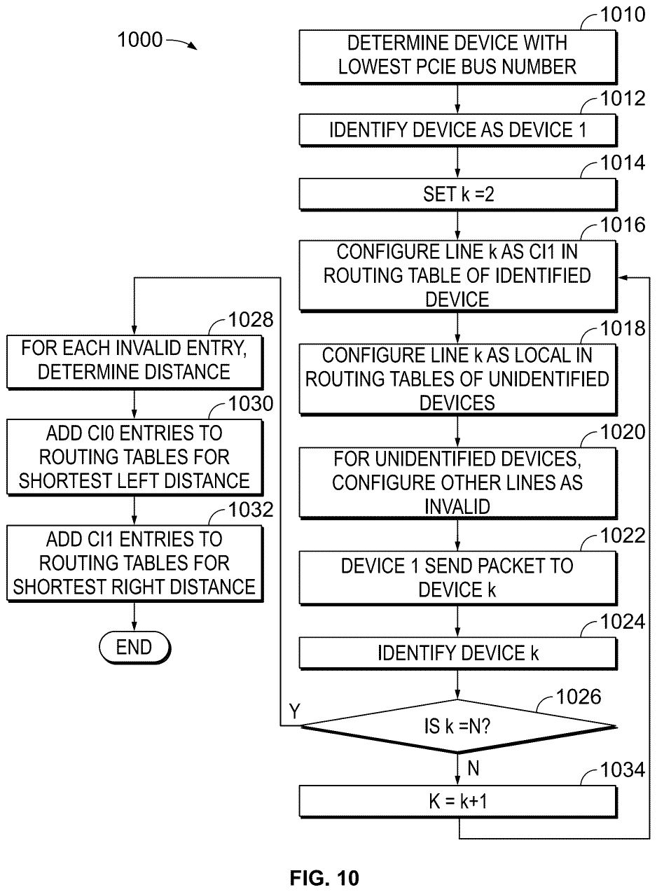

FIG. 10 is a flow diagram of the second example routine that populates the routing tables to provide high speed data flow amount the devices in FIG. 5. First the routine determines the device with the lowest PCIe bus number (1010). The determined device is identified as Device 1 with the associated line 1 in the routing table (1012). The next device, k is set to 2 (1014). Line k of the routing tables of the newly identified device is configured as CI1 (1016). Line k of the routing tables of all unidentified devices are configured as local (1018). All lines 2 to k−1, if they exist for the unidentified devices are configured to invalid (1020). A packet is sent from the first identified device to device k using the line of the routing table of the second identified device (1022). The second identified device passes the packet in turn until Device k is identified (1024). The routine determines if newly identified device k is the last device number N (1026). If the newly identified device k is the last device N, (1026), the routine will review each “invalid” entry for all lines in the routing tables and determine the distance to the corresponding devices (1028). The routine then updates all the invalid entries in the routing tables that are closer to the leftmost port (the CI0 port) of the corresponding device to CI0 (1030). The routine then updates all invalid entries in the routing tables that are closer to the rightmost port (the CI1 port) of the corresponding device to CI1 (1032). The routine then ends.

If the newly identified device k is not the last device N (1026), the routine increments k by one (1034) and loops back to configure new line k of the newly identified device (now k−1) (1016) and repeats the steps 1018-1026.

The flow diagrams in FIGS. 9-10 are representative of example machine readable instructions for identifying devices for the high-speed interconnect network. In this example, the machine readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowcharts illustrated in FIGS. 9-10, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The example routines may be run each time a new device is added or an existing device is removed or physically moved. Thus, the high speed ring network allows dynamic adjustments of the configuration of the computer systems.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A computer system comprising:
a host;
a bus having a plurality of lanes coupled to the host; and
a plurality of devices, each of the plurality of devices coupled to one or more of the lanes of the bus allowing communication to the host, wherein each of the devices of the plurality of devices is coupled to two neighboring devices via cables coupled to high speed input output ports to form a ring interconnection between the plurality of devices, wherein each of the devices are identified by identifying a first device and sending packets to each device to identify the other devices to allow high speed data traffic between the devices on the ring interconnection.

2. The system of claim 1, wherein each of the devices includes a plurality of processing cores coupled to a local device network.

3. The system of claim 1, wherein each of the devices is one of an array of processing cores, a FPGA, an ASIC, or a GPU card.

4. The system of claim 1, wherein the bus is a PCIe compliant bus.

5. The system of claim 4, wherein the first device is identified as a device of the plurality of devices with the lowest PCIe bus number.

6. The system of claim 1, wherein the host executes an identification routine that identifies the devices by updating corresponding routing tables for each of the identified devices, wherein each of the routing tables includes an entry for each of the plurality of devices and a corresponding high speed port.

7. The system of claim 6, wherein the host re-executes the identification routine when a device is added or a device is removed from the plurality of devices.

8. The system of claim 6, wherein the first identified device or a second identified device sends a packet to identify a third device and wherein the entry for third device in each of the routing tables of the unidentified devices is configured as local and each of the other entries of the corresponding routing tables for each of the unidentified devices is configured as invalid.

9. The system of claim 8, wherein after all devices are identified, the identification routine populates each of the invalid entries of the routing tables with a high speed port corresponding to the closest device for each listed device.

10. The system of claim 1, further comprising:
another host;
another bus having a plurality of lanes coupled to the another host;
another plurality of devices, each of the another plurality of devices coupled to one or more of the lanes of the another bus allowing communication to the another host, wherein each of the devices of the another plurality of devices is coupled to two neighboring devices via cables coupled to high speed input output ports, and wherein the another plurality of devices is part of the ring interconnection between the plurality of devices.

11. A method of configuring a high-speed ring network between devices coupled via a bus to a host, and wherein the devices include high speed ports coupled to neighboring devices via cables, the method comprising:
identifying one of the devices as a first device;
modifying an entry of a routing table of the identified first device to identify a high-speed port of the first device connected to a neighboring second device;
sending a packet through a ring network to the second device;
identifying the second device; and
modifying an entry of a routing table of the identified second device to identify a high-speed port of the second device connected to a third neighboring device.

12. The method of claim 11, wherein the devices comprise one of a device with a plurality of processing cores coupled to a local device network, a FPGA, an ASIC, or a GPU card.

13. The method of claim 11, wherein the bus is a PCIe compliant bus and wherein the first device is identified as the device with the lowest PCIe bus number.

14. The method of claim 11, wherein the host executes a routine to identify the first device, modify the entry of the routing table of the first device, send the packet, identify the second device, and update the routing table of the second device.

15. The method of claim 14, wherein the host re-executes the routine when a device is added or a device is removed from the plurality of devices.

16. The method of claim 11, wherein each of the devices include a routing table having entries corresponding to each of the plurality of devices, wherein the method further comprises updating the entries of all routing tables of all unidentified devices with an invalid entry.

17. The method of claim 16, further comprising configuring an entry of each of the routing tables corresponding to the identified second device as local.

18. The method of claim 17, further comprising:
sending a packet through the ring network to the third neighboring device;
identifying the third neighboring device; and
modifying an entry of a routing table of the identified third neighboring device to identify a high-speed port of the third device connected to a fourth neighboring device.

19. The method of claim 18, wherein either the first device sends the packet to the third neighboring device, or the second device sends the packet to the third neighboring device.

20. The method of claim 18, further comprising:
repeating the sending, identifying and modifying until all devices of the plurality of devices are identified;
configuring all invalid entries in all of the routing tables according to a high speed port of the corresponding device closest to the device corresponding to the entry.
